(19) United States
(12) Patent Application Publication
(10) Pub. No.: US 2014/0103756 A1
(43) Pub. Date: Apr. 17, 2014

(54) SELF-SUPPORTING HOUSING OF A DYNAMOELECTRIC MACHINE

(71) Applicant: Siemens Aktiengesellschaft, Munchen (DE)

(72) Inventors: Reiner Grillenberger, Windsbach (DE); Gerhard Dorr, Allersberg (DE); Thomas Koch, Numberg (DE); Martin Sidelka, Nurnberg (DE); Ulrich Werner, Bubenreuth (DE)

(21) Appl. No.: 14/119,647

(22) PCT Filed: May 24, 2011
(86) PCT No.: PCT/EP2011/058407

§ 371 Date: Nov. 22, 2013

(51) Int. Cl. H02K 1/18; H02K 5/20; H02K 5/24

(52) U.S. Cl. CPC H02K 1/185; H02K 5/24; H02K 5/20
USPC 310/51; 310/216.118; 310/52

(57) ABSTRACT

A self-supporting housing of a laminated core of a stator in a dynamoelectric machine has a laminated core section surrounding the laminated core which is formed by axially stacked sheets and includes at least one pressure plate on its faces. The inside of the laminated core section is designed such that a laminated core having a basic shape of an octagonal cross-section can be accommodated in the laminated core section, wherein shorter sides and longer sides of the laminated core alternate in the peripheral direction; at least one connecting section in the axial extension of the laminated core section to dispose additional elements and/or devices on the housing. Contact zones are provided on the inside of the laminated core section to dispose and secure the laminated core in such a way that a gap is formed between the contact zones.

The invention relates to a self-supporting housing for a laminated core of a stator of a dynamoelectric machine, a laminated core of a stator for positioning in a self-supporting housing, and a dynamoelectric machine having a laminated core of a stator in a housing.

There are a multiplicity of motor concepts for air and water cooling, for mounting the terminal box, for arranging bearings, and also for a material embodiment of the cooling concept for a dynamoelectric machine. Thus, an air cooling concept is known from EP 0 87 743 A1. A housingless rotary current machine having axially parallel cooling medium pipes in a stator laminated core is described in DE 197 42 255 C1. Similarly, liquid-cooled electric machines are known from U.S. Pat. No. 5,084,642 A and DE 91 12 631 U1, wherein in said arrangements redirecting channels and inlet and outlet ports are cast into the end shields. In these cases any change in the frame size (frame size), the type of cooling, the arrangement of the terminal box etc. leads to a virtually completely new construction and design of the dynamoelectric machine.

Housingless electric machines are characterized by a lack of rigidity and in order to mount the shaft they need to be provided with pot end shields, said end shields being comparatively complicated and expensive. A housingless electric machine is known from AT 170 766, the lamination plates of said machine having cooling and root extensions.

Dynamoelectric machines with housing lead to an increase in size of the active component, since, among other things, the cooling function is not provided to the same extent as in the case of a housingless machine.

Proceeding from this basis, the object underlying the invention is, while taking account of the new efficiency classes, to provide a dynamoelectric machine, in particular for the low-voltage level, which is comparatively simple to manufacture and which avoids the aforementioned disadvantages.

The object addressed is successfully achieved by means of a self-supporting housing of a laminated core of a stator of a dynamoelectric machine, said housing having the following features:
a laminated core section surrounding the laminated core, wherein the laminated core is formed by means of axially layered lamination sheets and on each of its end faces has at least one pressure plate, wherein the inside of the laminated core section is designed in such a way that a laminated core having a basic shape in the form of an octagonal cross-section can be accommodated, wherein, when viewed in the peripheral direction, shorter sides and longer sides of the laminated core are present in alternation,
at least one connecting section in axial extension of the laminated core section in order to enable further elements and/or devices to be positioned on the housing,
predefined bearing zones of the laminated core on the inside of the laminated core section of the housing in order to position and fix the laminated core,
when viewed in the peripheral direction and/or in the axial direction, a free space is provided between the bearing zones.

The addressed object is furthermore successfully achieved by means of a dynamoelectric machine having a laminated core, wherein cooling units for stator and/or rotor are provided at connecting sections.

According to the invention, said self-supporting housing has a simple angular laminated core section comprising an angular laminated core. In addition, the self-supporting housing according to the invention has at least one connecting section in axial extension adjoining the laminated core section. Where there are a plurality of connecting sections, these are arranged on both sides at the axial ends of the laminated core section.

According to the invention, the functions of the self-supporting housing are now clearly defined and delineated. This results in a platform concept which henceforth enables individual embodiment variants (for example, liquid cooling, air cooling, machine with and without soundproofing, heat exchanger on machine, terminal box on top or at the side, etc.) to be realized in a simple manner, without the need to develop a new machine concept from the outset and put it into production.

Thus, the laminated core section of the housing serves for fixing the laminated core of a stator by way of the specified bearing zones between laminated core section and laminated core, in particular as a torque reaction member and/or for packaging the laminated core.

In another embodiment variant, the lateral surfaces of the laminated core section of the housing are open, such that only a frame, possibly reinforced by one or more struts, fulfills the aforementioned functions. As its basic shape, the laminated core section therefore takes the form of a regular prism with reinforced edges.

In its axial extension, the connecting section is immediately and directly arranged adjacent to the laminated core section. Connecting section and laminated core section are advantageously made of one material, and more particularly embodied as a single piece.

The self-supporting housing together with its laminated core section and its connecting section is of extremely simple construction and consists of only a few basic elements. These can be fabricated from steel, cast steel or cast iron or even from aluminum.

All possibilities for connecting supplementary devices and/or auxiliary units, e.g. for airflow routing, air distribution, mounting of a fan, mounting of add-on heat exchangers, end shields, terminal boxes, etc., are now realized exclusively by way of one or the other connecting sections of the housing. Where there are two connecting sections, the laminated core section is disposed between said two connecting sections. Functions or connection options of the connecting section that are not used, for example because only an external means of cooling is provided, but no add-on heat exchangers, can be covered or sealed by means of blanking plugs or blind covers on the connecting section. This simplifies the basic structure of the housing, since only one housing must now be provided for one frame size of a dynamoelectric machine, by means of which housing all connection and cooling possibilities can be realized.

For example, this enables all types of cooling, such as e.g. self- or externally ventilated, water-cooled or water-cooled with external ventilation, as well as a separate add-on heat exchanger to be realized.

Advantageously, thanks to the very simple housing with its connecting sections, the location of the terminal box is virtually freely selectable, since the mounting of the terminal box is tied only to the connecting section and not to specific receiving surfaces, as e.g. in the case of a ribbed housing.

Basically, the laminated core of the stator is designed as an octagonal basic shape, with shorter and longer sides being arranged alternately, when viewed in the peripheral direction.

The peripheral direction, in the present context, is defined as an imaginary plane which is arranged vertically on the virtual machine axis. Said plane runs parallel to the individual lamination plates of the laminated core.

On their external sides—with the exception of the bearing zones—the metal lamination plates arranged as the laminated core have surface-enlarging structures. In addition, axially extending recesses are provided in this case, including in the laminated core. These surface-enlarging structures, such as cooling fins or clip grooves for cooling pipes and/or the axial recesses, are called upon during the operation of the dynamoelectric machine for air or liquid cooling. This enables the machine to be implemented in a simple manner either as a liquid-cooled or as an air-cooled machine. A combination cooling solution (air and liquid) is obviously also possible without major modification to the machine.

The bearing zones are advantageously provided on the shorter sides, such that a predefined clearance can be set between a sidewall of the laminated core section of the housing and a longer side of the laminated core. Noise-absorbing mats, for example, can be inserted into this space. Noise emissions are reduced as a result of the minimized contact between laminated core and housing. Said emissions can be further reduced by means of the soundproofing materials.

Furthermore, an optimized use of material is achieved as a result of the inventive dynamoelectric machine with its self-supporting housing and its laminated core, since now, unlike in the case of a round laminated core, the corners of the laminated core can be used as well. The use of a self-supporting housing also makes for a housing having a high degree of rigidity. This enables the torques to be absorbed. When the electric machine is in operation, these are the turning moments, as well as the short-circuit torques in the event of a short circuit.

If the sidewalls of the laminated core section are closed, the laminated core is protected against corrosion effects, among other things.

The protection classes specified in IEC 34-7 can be easily realized by means of the construction of a dynamoelectric machine according to the invention.

The construction according to the invention can also be implemented particularly cost-effectively, since, thanks to the use of said self-supporting housing, expensive pot end shields are replaced by standard end shields. The end shields are arranged in the connecting sections.

The self-supporting housing, when viewed in the peripheral direction, can advantageously be designed as a single-part, two-part or multipart structure in order thereby to enable the housing to be handled better during assembly in particular in the case of dynamoelectric machines having greater frame sizes. After being positioned on the laminated core, the individual parts are then connected to one another in a force-fit manner in order to be able to absorb the aforementioned torques.

At its end faces the laminated core of the stator essentially has pressure plates applied which compress the individual axially layered lamination plates against one another.

According to an exemplary embodiment, the pressure plates correspond in the region of the stator bore and where applicable the grooves and also any cooling recesses to the dimensions of the lamination plates, though they are larger in their outer diameter than the individual lamination plates. This results in the advantage that only the pressure plates come to rest at the predefined bearing zones on the inside of the laminated core section of the housing. In this way a free space between the surface of the laminated core and the inside of the laminated core section is created between the sides of the laminated core, which advantageously has an octagonal basic shape, with shorter and longer laminated core sides. Into this free space can now be inserted soundproofing materials, advantageously already prefabricated soundproofing mats, which can be tuned to predefined oscillation frequencies and noise frequencies of the motor and/or an inverter connected to the motor and thus filter out certain frequencies right from the outset.

By being arranged internally the soundproofing materials are now protected from external influences such as atmospheric conditions or mechanical damage and as a result their functional integrity is maintained over a longer time. Furthermore, the soundproofing mats are contained in an enclosed free space and so cannot creep into the winding or rotor due to vibrations of the laminated core.

The soundproofing mats are advantageously glued, screwed or secured by means of retaining eyelets to the laminated core or on the inside of the laminated core section. Said soundproofing mats lead to a noise reduction, which is extremely important in particular during operation of the dynamoelectric machine with the inverter. Said noises are produced due to mechanical oscillations of the windings which are arranged in the grooves of the stator and mutually magnetically repel and attract one another at the pulse frequency.

As a result of this additional measure, noise limit values are to be complied with without the need for changes to the inverter controller. Consequently, inverters can continue to be operated at a low clock frequency, i.e. in particular still inside the audible range <16 kHz, with dynamoelectric machines according to the invention. Higher clock frequencies furthermore lead to higher power dissipation losses of the inverters.

In another embodiment variant, the pressure plates correspond in their external dimensions at least in the region of the bearing zones to those of the lamination plates of the stator laminated core. Thus, both the pressure plates and the lamination plates of the laminated core bear with their shorter sides against the bearing zones. Accordingly, when viewed in the peripheral direction, four contact zones are established between the bearing zones of the laminated core section of the housing and the laminated core. Each contact zone extends axially, starting with the shorter side of the pressure plate, via the shorter side of the individual lamination plates of the laminated core, to the possibly shorter side of the second pressure plate. Axially extending contact zones are therefore established between the surface of the laminated core and the inside of the laminated core section in the bearing zones. Between said axially extending contact zones there are now free spaces between the surface of the laminated core and the inside of the laminated core section. Soundproofing materials, in particular soundproofing mats having the above-described advantageous effects, can also be inserted into these free spaces in the above-explained manner.

The invention as well as further advantageous embodiments of the invention are explained in more detail below with reference to exemplary embodiments schematically illustrated in the drawings, in which:

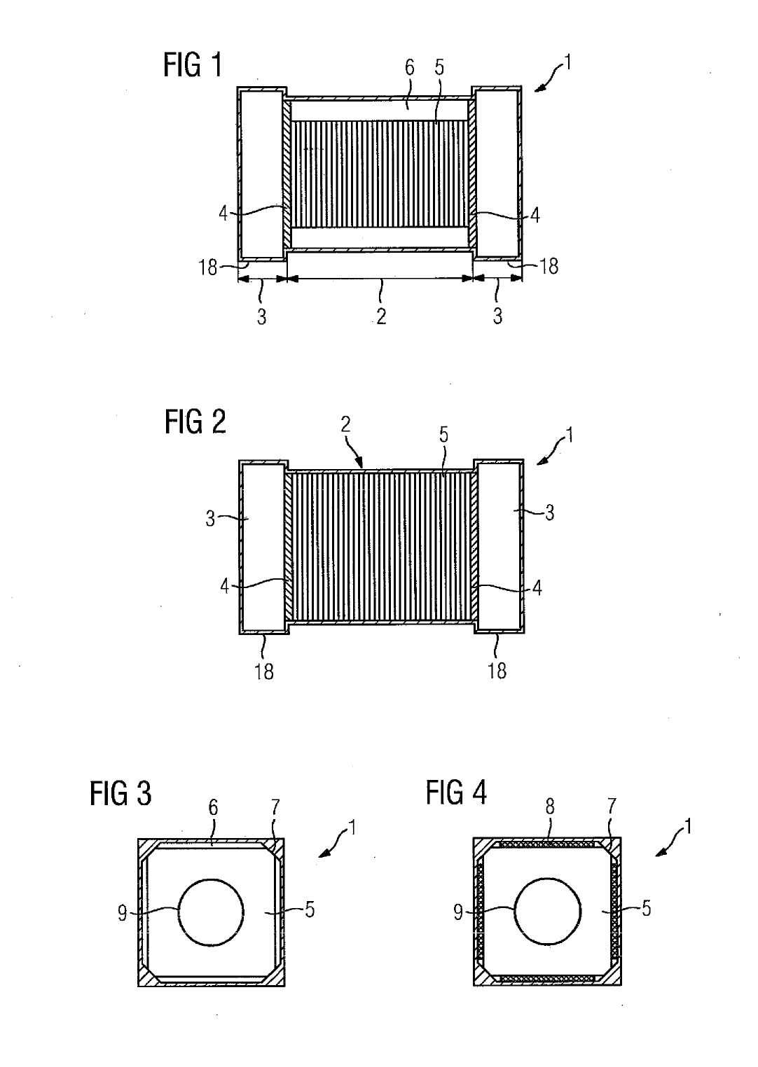

FIG. 1 shows a schematic longitudinal section through an embodiment variant,

FIG. 2 shows a schematic longitudinal section through a further embodiment variant,

FIG. 3 shows a cross-section through an embodiment variant according to FIG. 1,

FIG. 4 shows a cross-section through an embodiment variant having soundproofing mats,

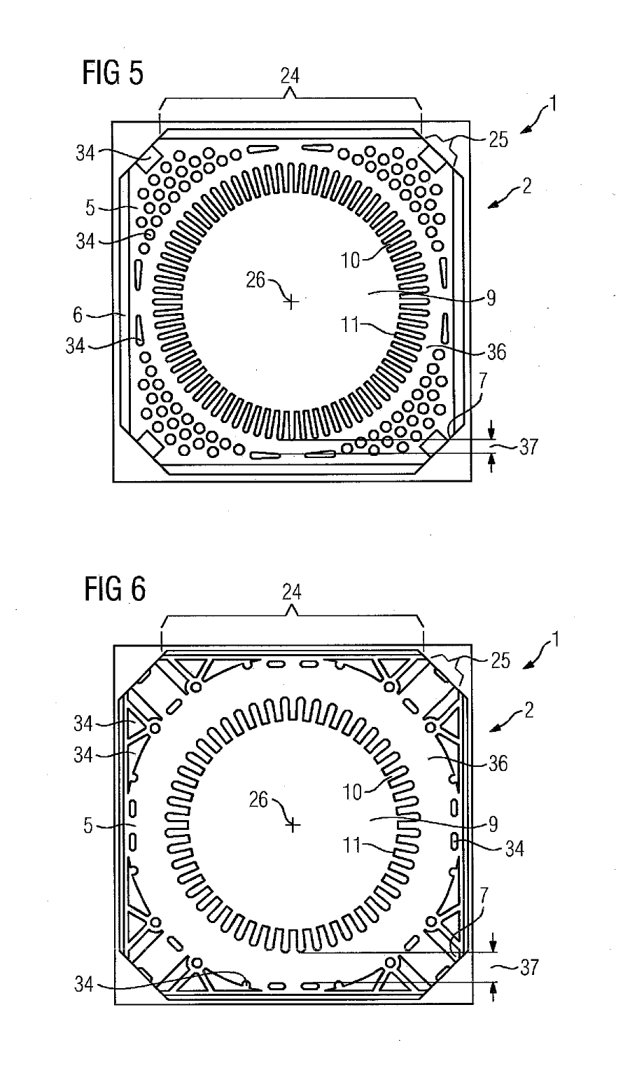

FIGS. 5, 6 show embodiment variants of different laminated cores in the housing,

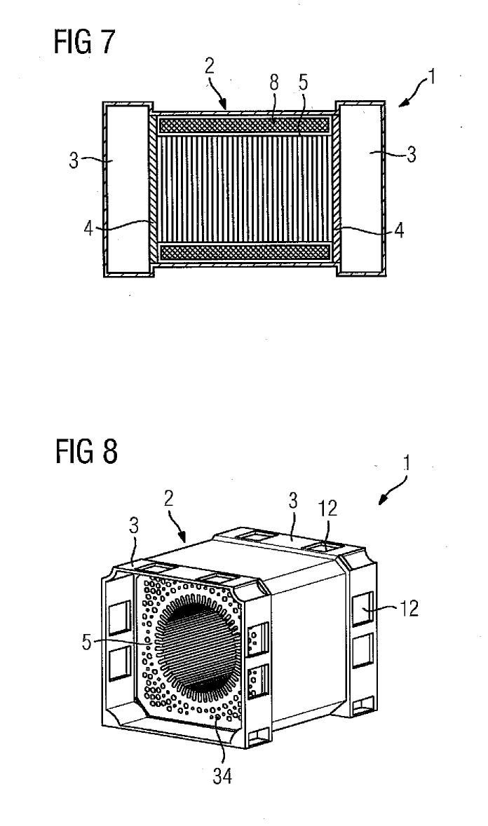

FIG. 7 shows an embodiment variant according to FIG. 1 having soundproofing mats,

FIG. 8 shows a housing with laminated core,

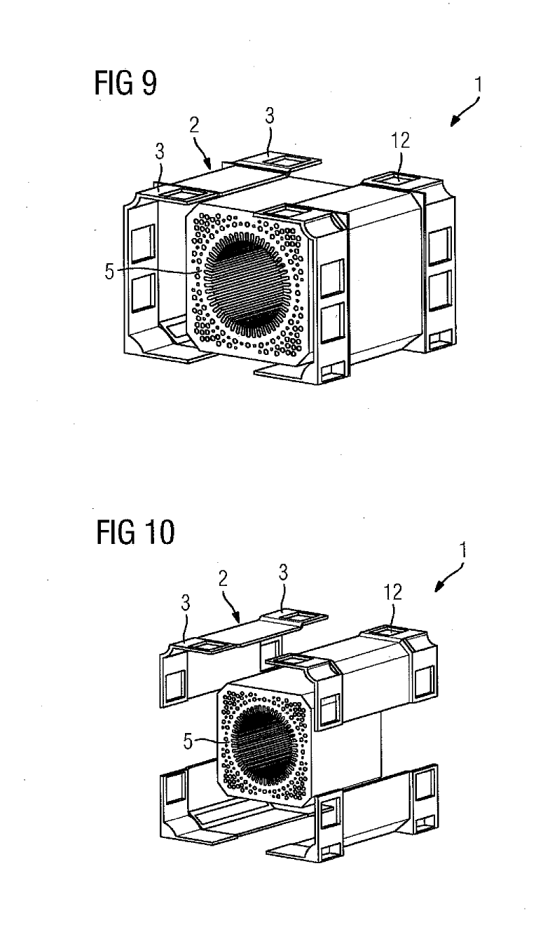

FIGS. 9, 10 each show a multipart housing,

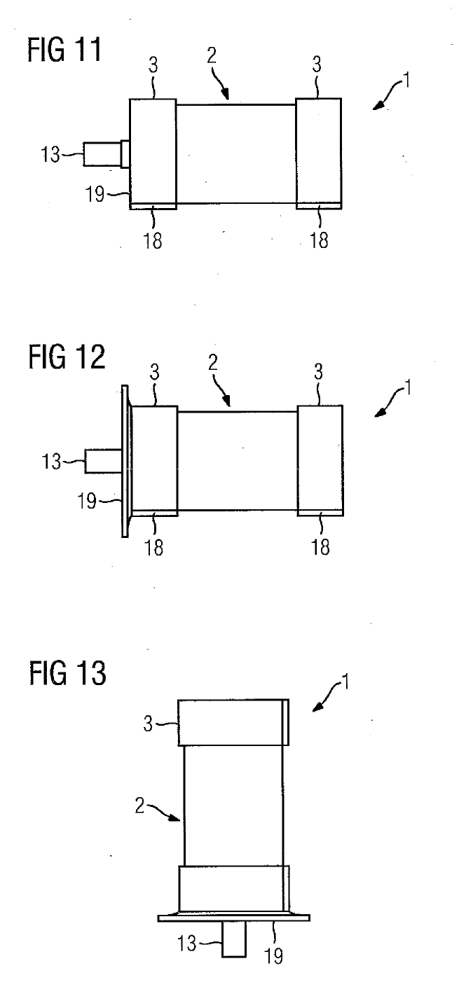

FIGS. 11 to 13 show different bearing arrangements on a housing,

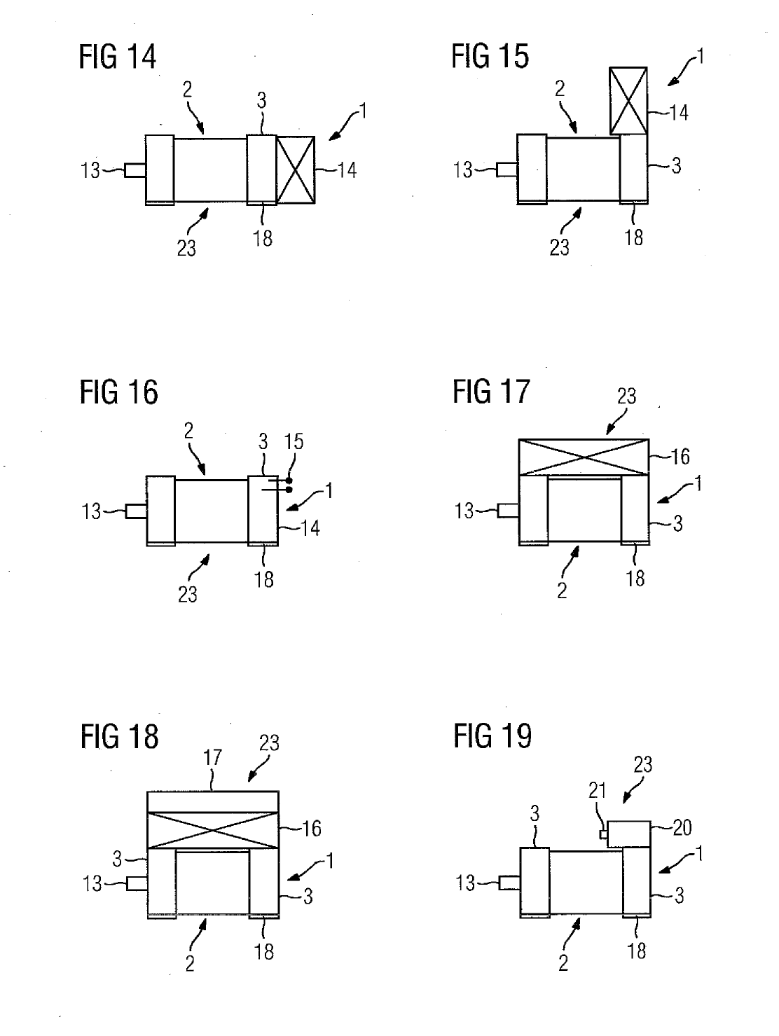

FIGS. 14, 15 show different arrangements of cooling devices on a housing,

FIG. 16 shows a schematic liquid cooling connection to a housing,

FIGS. 17, 18 show add-on heat exchangers and add-on inverters on a housing,

FIG. 19 shows the arrangement of a terminal box on the housing,

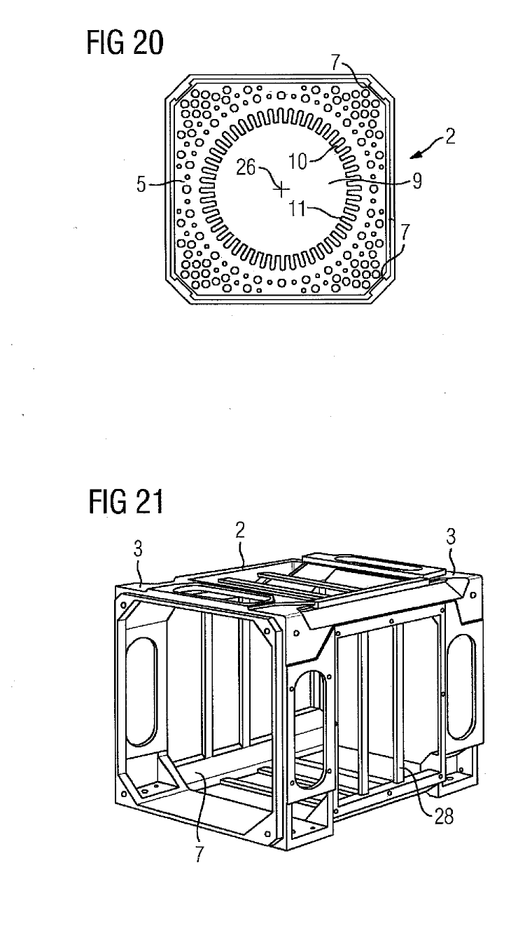

FIG. 20 show bearing zones of the housing,

FIGS. 21 to 24 show further embodiment variants of the housing, and

FIG. 25 shows a perspective view of a dynamoelectric machine.

FIG. 1 shows in a schematic representation a longitudinal section through an inventive self-supporting housing 1 of a dynamoelectric machine 23 having a stator 22 whose laminated core 5 is formed by pressure plates 4 at the end faces of axially layered lamination plates. In the construction type of a self-supporting housing 1, housing parts or housing sections, reinforcements, profiles and panelings are connected to one another in a nondetachable manner by means of different joining techniques (soldering, welding, gluing). In this arrangement the supporting function is assumed solely by means of said housing structure. The rigidity is achieved through the compact housing structure by means of (possibly hollow) housing parts having the largest possible cross-section and therefore a high section modulus. Reinforcing seams, impressions, etc., as shown in FIG. 8 and FIG. 23 for example, increase the rigidity.

The housing 1 must in particular support the torques arising during operation, therefore serving as a torque reaction member also for the torques occurring in the event of a short-circuit.

The pressure plates 4 package the laminated core 5 and compress it such that extremely narrow gaps result between the lamination plates. Dust or moisture can nonetheless penetrate into the gaps due to capillary action. The housing 1 has a laminated core section 2 and connecting sections 3 axially adjacent thereto. In this view the connecting sections 3 are different in height from the laminated core section 2. They can equally be embodied with the same cross-section or, as can be seen in FIG. 1, with a greater cross-section.

In this case the laminated core section 2 absorbs the torque generated during operation from the laminated core 5 by way of the pressure plates 4 and passes on same to the connecting sections 3, which are connected to a base for example.

If the connecting sections 3 are embodied with a greater cross-section, the lower regions of the connecting sections 3 in this case simultaneously form feet onto which the dynamoelectric machine 23 is to be placed during operation.

The laminated core 5 is arranged, as also shown in FIG. 1, only within the laminated core section 2. The laminated core section 2 of the housing 1 has no further function or connection possibilities for external add-on elements, such as fans, etc. It serves for positioning and if necessary for protecting the laminated core 5. For assembly purposes it is simply advantageous if the connecting sections 3 and/or the laminated core section 2 provide possibilities for ring bolts 27.

FIG. 2 shows a longitudinal section through a dynamoelectric machine 23, the differences compared to FIG. 1 consisting in the lamination plates of the laminated core 5 and also the pressure plates 4 having the same diameter and the same cross-section at least in predetermined outer peripheral sections. In this arrangement the entire laminated core 5 is likewise disposed in the laminated core section 2 of the housing 1.

In FIG. 1, the laminated core 5 consisting of axially layered lamination plates which are packaged by means of pressure plates 4 is supported only by means of the pressure plates 4 on the inside of the laminated core section 2 of the housing 1 in the bearing zones 7 provided therefor. The lamination plates have no contact with the internal sides of the laminated core section 2. This means that the torques of the electric machine are conducted into the laminated core section 2 only via the contact zones of the pressure plates 4 with the bearing zones 7.

According to FIG. 2, both the shorter sides of the pressure plates 4 and the predefined sections of the laminated core 5, i.e. the shorter sides of the lamination plates, are in contact in the bearing zones 7 of the laminated core section 2, as can also be seen from FIG. 3.

FIG. 3 shows that in particular the laminated core section 2 of the housing 1 can be embodied in its external basic shape in the form of a square or octagon. The inside of the laminated core section 2 of the housing 1 forms an octagon which in particular at the shorter internal sides forms the bearing zones 7 for the laminated core 5 and/or only for the pressure plates 4 of the laminated core 5.

Arranged in a stator bore 9 during the operation of the dynamoelectric machine is a rotor which is rotatably mounted in end shields and which, through electromagnetic interaction with the winding system of a stator 22, generates a torque for driving a work machine for example.

Prefabricated soundproofing mats 8 which are advantageously tuned to certain frequencies of the inverters supplying the dynamoelectric machine 23 with electricity are, as FIG. 4 shows, inserted into the resulting free spaces 6 between the inside of the laminated core section 2 and the surface of the laminated core 5. Accordingly, the inverter can continue to be operated at a low clock frequency.

The soundproofing mats 8 have a very simple rectangular shape and can be procured already prefabricated. They are not visible from outside and because they are arranged internally are protected from external influences such as atmospheric exposure or adverse mechanical effects or from sliding out of place.

Furthermore, the soundproofing mats 8 are advantageously fixed to the inside of the laminated core section 2 or to the laminated core 5 by means of gluing, screwed connections or additional retaining eyelets, thereby preventing any shifting out of position inside the free space 6. This rules out any possibility of the soundproofing mats 8 being displaced into the region of the winding of the stator 22 or rotating parts of the dynamoelectric machine 23 due, for example, to vibrations during the operation of the electric machine.

FIG. 5, FIG. 6 show schematic cross-sectional shapes of lamination plates of different laminated cores 5, each of which is arranged in the laminated core section 2. The lamination plates essentially have an octagonal basic shape from which no departure is made in spite of surface-enlarging measures such as notches, cutouts, clip grooves on the outer periphery or inside the lamination plate. In this case the octagonal basic shape has shorter sides 25 and longer sides 24 which alternate in the peripheral direction and so enable the laminated core 5 to be positioned and fixed by way of its shorter sides 25 and the bearing zones 7 on the inside of the laminated core section 2 of the housing 1.

In this arrangement the lamination plates are aligned vertically with respect to a virtual axis 26. In the direction of the stator bore 9, the laminated core 5 has grooves 10 and teeth 11, a winding system being arranged in the grooves.

Radially outwardly adjoining this is a yoke back 36 which preferably has no cutouts influencing the magnetic flux line characteristics. In this case the radial extension 37 of the yoke back 36 is preferably at least half as great as the depth of a groove 10.

The cutouts 34 on and in the lamination plates, e.g. the clip grooves, and ultimately also in the laminated core 5, form axially extending cutouts. These are suitable for accommodating cooling pipes of a liquid cooling means of the dynamoelectric machine 23 and/or serve as ventilation ducts of an integral or external ventilation system of the dynamoelectric machine.

FIG. 7 shows the embodiment variant according to FIG. 1 in a schematic longitudinal section, with soundproofing mats 8 now being arranged in the free spaces 6.

FIGS. 9 and 10 show that the entire self-supporting housing 1 (according to FIG. 8) can be assembled from a plurality of axially split sections. This is particularly advantageous in the case of dynamoelectric machines having a greater frame size. The assembly and handling of the housing 1 are simplified in this case. In such an arrangement each axial section has the corresponding portions of the laminated core section 2 and the connecting sections 3.

The individual sections are assembled in a force-fit manner in order to enable the required torque reaction member to be formed.

All connection variants necessary for the operation of a dynamoelectric machine 23 are now possible in the connecting section 3 through openings 12. Said connection variants are, for example, connections of terminal boxes, fans, air exchange apertures for heat exchangers, etc. If said openings 12 are not required for a specific machine type and/or intended application, they can be closed off by means of simple covers 33.

FIG. 11 shows an embodiment variant in which a shaft stub 13 protrudes axially out of the housing 1, to which stub a work machine can be mechanically coupled. In this case an end shield 19 is arranged in the left-hand connecting section 3.

As FIGS. 12 and 13 show, other different end shields 19 are conceivable in the connecting section 3, in which case the particular application and purpose of the work machine, as well as the type of installation (horizontal or vertical shaft 13) should be taken into consideration in the choice of the end shields 19. According to the invention, this consideration now takes place in the connecting section 3, with feet 18, for example, being connected to a base.

This enables types of construction of electric machines according to IEC 34-7 to be realized in a simple manner.

FIG. 14 shows another advantageous embodiment of the inventive concept, namely that a fan device 14 can now be connected to the connecting section 3. This enables external cooling of the dynamoelectric machine 23. The laminated core section 2 remains unaffected by this in constructional terms.

Furthermore, according to FIG. 15, a cooling device or an external heat exchanger can also be arranged above the connecting section 3.

FIG. 16 shows the possibility in principle of connecting a liquid cooling system 15 to the dynamoelectric machine 23. For this purpose cooling pipes must of course be arranged within the cutouts inside or on the laminated core 5 of the stator 22 and interconnected in accordance with the desired flow configuration. A meander-like routing of the cooling pipes, when viewed in the peripheral direction, is preferably aimed at in this case.

FIG. 17 shows in a further embodiment variant the housing 1 with its laminated core section 2 and the two connecting sections 3. The openings 12 of the connecting sections 3 lead into a heat exchanger 16, advantageously air-to-air or air-to-water heat exchanger, wherein the heated or recooled cooling air is conducted away or supplied, respectively, by way of openings 12 provided therefor in the connecting sections 3 of the dynamoelectric machine 23. The laminated core section 2 remains unaffected thereby.

In addition to the embodiment variant according to FIG. 17, FIG. 18 shows an inverter 17 which is positioned on the heat exchanger 16. The inverter 17 is also cooled by the heat exchanger 16. For that purpose the electrical connecting leads are supplied through the heat exchanger 16 and by way of the connecting section 3 to the winding system of the stator 22 of the dynamoelectric machine 23.

FIG. 19 shows a terminal box 20 on the connecting section 3, the terminal box 20 being able to be adjusted with the orientation of its external electrical connection 21 in a wide variety of directions in order thereby to facilitate the external electrical connection 21.

All connecting elements such as terminal box 20, heat exchanger 16, inverter 17, etc. can be mounted singly or in any combination on the connecting sections 3 by way of the openings 12.

FIG. 20 shows bearing zones 7 of the laminated core section 2 which are embodied in the shorter sides of the octagonal housing 1. By means of said bearing zones 7 a free space 6 is created between the inside of the laminated core section 2 and the surface of the laminated core 5, which free space, as explained above, can be filled out with soundproofing materials.

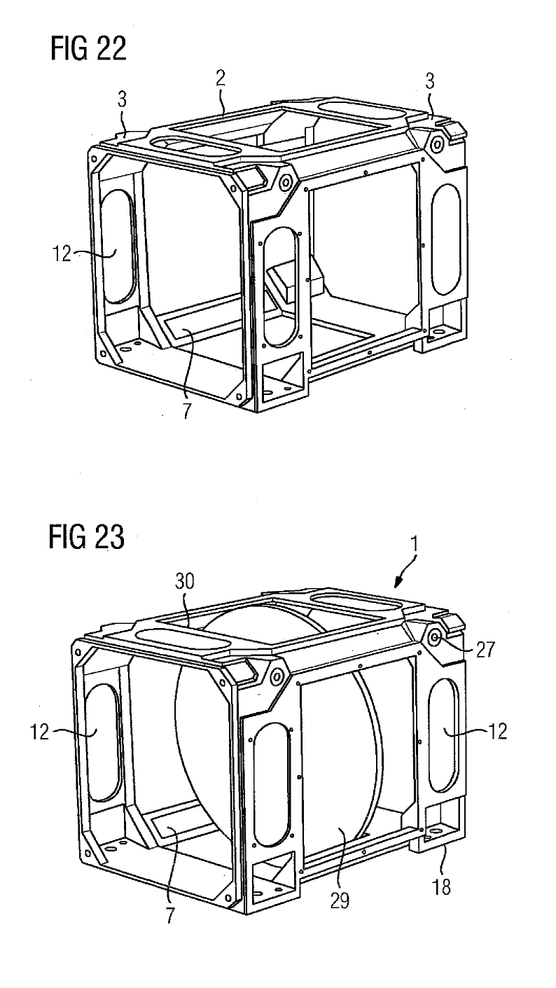

FIG. 22 shows a housing 1 in which the basic inventive concept has been preserved in comparison with the hitherto described embodiment variants, yet the sidewalls 35 are open in the laminated core section 2. A higher rigidity compared with housingless machines is likewise achieved in this way.

At the same time the original sidewalls 35 can also be replaced. Any gap can be sealed by means of a variety of different sidewalls 35. The vibration characteristics of the housing 1 are influenced by sidewalls 35 made of a different or, as the case may be, thicker or thinner material (plastic, GRP, . . . ). In this case sidewalls 35 with an insert project into the free space 6. These are for example retaining elements for soundproofing material or perforated metal sheets.

However, in order to increase the rigidity further, as shown in FIG. 21, stays 28 are provided in the remaining openings of the sidewalls of the laminated core sections 2.

As a result of the absence of sidewalls in the laminated core section 2, the bearing zones 7 can, as FIG. 23 shows, be particularly easily worked for example by means of a turning chisel of a machine tool, since the operating ranges 29 of a turning chisel project beyond the delimiting edges 30.

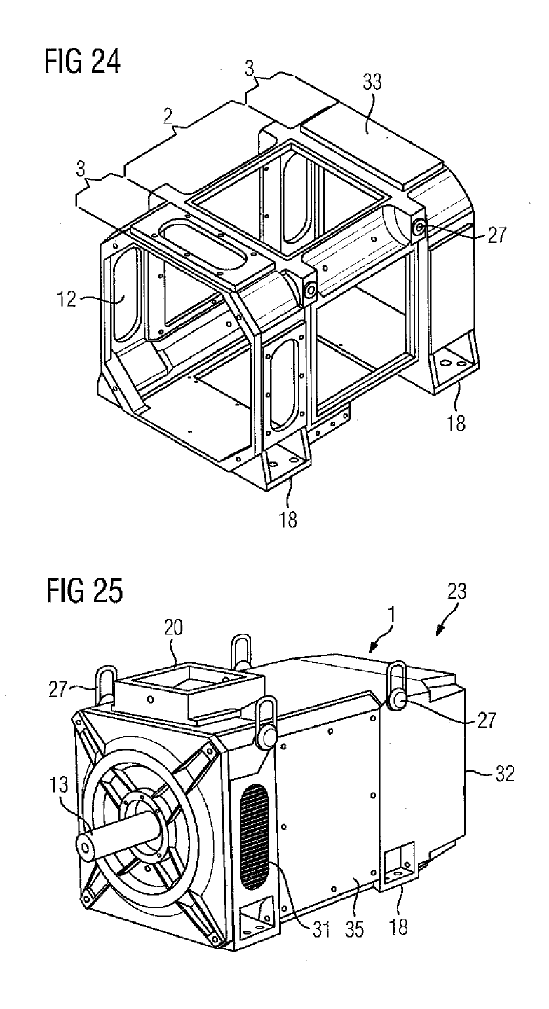

FIG. 24 shows a perspective view of a housing 1 which has material accumulations at the axial ends of its laminated core section 2 which are particularly suitable for attaching a ring bolt 27.

FIG. 25 shows a dynamoelectric machine 23 in a possible embodiment variant of the described platform concept, wherein at one connecting section 3 there protrudes the shaft stub 13 which is held in an end shield 19 in said connecting section 3. Furthermore, an opening 12 of said connecting section 3 is provided with a ventilation grille 31, a terminal box 20 and ring bolts 27. The other connecting section has a ventilation shroud 32. The sidewall 35 is covered separately.

1.-9. (canceled)

10. A dynamoelectric machine, comprising:
a stator having a laminated core formed by axially layered lamination plates, and pressure plates respectively arranged at end faces of the laminated core; and
a self-supporting housing having
a laminated core section disposed in surrounding relationship to the laminated core and having an inside of octagonal configuration so that the laminated core has a basic shape in the form of an octagonal cross-section, thereby defining alternatingly short sides and long sides, when viewed in a peripheral direction,
at least one connecting section in axial extension of the laminated core section for positioning of further elements or devices on the housing, and
predefined bearing zones provided for the laminated core on the inside of the laminated core section of the housing to position and fix the laminated core, with a free space being provided between bearing zones, when viewed in the peripheral direction or in an axial direction, said bearing zones of the laminated core section being provided in the short sides of the housing.

11. The dynamoelectric machine of claim 10, wherein the laminated core of the stator is supported exclusively by the pressure plates in the bearing zones of the laminated core section of the housing.

12. The dynamoelectric machine of claim 10, wherein the laminated core of the stator is supported by the pressure plates.

13. The dynamoelectric machine of claim 10, wherein the short sides of the laminated core of the stator are supported in the bearing zones of the laminated core section.

14. The dynamoelectric machine of claim 10, wherein the free space between the bearing zones is demarcated by a surface of the laminated core and an internal side of the laminated core section, and further comprising soundproofing material provided in the free space.

15. The dynamoelectric machine of claim 14, wherein the soundproofing material is implemented in the form of a soundproofing mat.

16. The dynamoelectric machine of claim 14, wherein the soundproofing material is tuned to predefined absorbing frequencies.

17. The dynamoelectric machine of claim 10, wherein, when viewed in the peripheral direction, the self-supporting housing is designed as a single-part, two-part or multipart structure.

18. The dynamoelectric machine of claim 10, further comprising an add-on element selected from the group consisting of cooling system, terminal box, and end shield, mounted exclusively by the connecting section.

19. The dynamoelectric machine of claim 10, further comprising a cooling unit for stator or rotor at the connecting section.
